(19) United States
(12) Patent Application Publication
(10) Pub. No.: US 2009/0297293 A1
(43) Pub. Date: Dec. 3, 2009

(54) VEHICLE NUT HOLDING APPARATUS

(75) Inventor: Peter J. H. CHANG, Taipei (TW)

Correspondence Address: Muncy, Geissler, Olds & Lowe, PLLC, P.O. BOX 1364, FAIRFAX, VA, 22038-1364, US

(73) Assignee: TAPER PRO INDUSTRIAL, INC.

(21) Appl. No.: 12/131,538

(22) Filed: Jun. 2, 2008

(51) Int. Cl. F16B 37/00

(52) U.S. Cl. 411/427

(57) ABSTRACT

A vehicle nut holding apparatus aims to improve the disadvantages of conventional holding apparatus that are difficult to fabricate and assemble, and cannot hold vehicle nuts securely and differentiate usage of the nuts. The holding apparatus of the invention has a plurality of housing troughs to hold a plurality of vehicle nuts. Each vehicle nut has at least one protrusive portion and one indented portion adjacent to each other. Each housing trough has a bottom and a side wall abutting the bottom. The side wall has a retaining recess corresponding to the protrusive portion and a retaining boss corresponding to the indented portion. The retaining recess is located between the retaining boss and the bottom. The retaining recess and retaining boss can retain the vehicle nut and allow the vehicle nut to be held in a displaying manner to indicate its usage.

### FIELD OF THE INVENTION

The present invention relates to a holding apparatus and particularly to a vehicle nut holding apparatus to facilitate use and display.

### BACKGROUND OF THE INVENTION

The general vehicle wheel of tires has to be fastened to an axle to form concurrent rotation. The wheel has a plurality of lug holes mating screw struts or screw holes formed on the axle (according to production specifications). A nut or bolt is selected according to the screw struts or screw holes to engage with each lug hole to fasten the wheel to the axle. Reference of vehicle nuts can be found in R.O.C. utility patent U.S. Pat. Nos. M268,469 and 559,252.

U.S. Pat. No. M2,684,469 discloses a nut structure to fasten a wheel. It is made of light weight aluminum alloy, and has a screw hole at a front end and an aperture running through a rear side of the screw hole. It also has a conical head at the front end and a hexagonal section behind the conical head. The screw hole holds a strengthened reinforced screw bushing which has a diamond cross section corresponding to the internal screw of the screw hole. A bolt is provided to fasten the reinforced screw bushing to a vehicle axle fastening disk.

U.S. Pat. No. 559,252 discloses a theft-proof nut and bushing for fastening a wheel to a vehicle axle. The nut has a plurality of indented force receiving portions on the surface thereof that are formed in varying sizes and arranged in a selected sequence. The conventional coupling sleeve cannot be engaged with the nut, thus a theft-proof effect can be accomplished.

A holding apparatus 1 as shown in FIG. 1 usually is provided to hold the vehicle nuts previously discussed. The holding apparatus 1 has a first holder 101 and a second holder 102 made from flexible sponge that have respectively a plurality of apertures 103, 105, 104 and 106 that correspond to and communicate with each other to hold a plurality of vehicle nuts 20. When in use two vehicle nuts 20 are held alternately in the apertures 103 and 104, while another vehicle nut 20 runs through the other apertures 105 and 106 to couple the first and second holders 101 and 102 together. It takes a lot of time to assemble. Moreover, with the vehicle nuts 20 are held in the apertures 103, 105, 104 and 106, their profiles cannot be seen clearly, and their structure and usage cannot be differentiated. It becomes a big annoyance to users. Furthermore, as the apertures 103, 105, 104 and 106 are through holes running through two sides, the holding apparatus 1 could be flipped upside down during transportation and result in dropping of the nuts 20 under gravitational force. In addition, the flexible material forming the holders does not provide an adequate retaining force. All this indicates that there are still rooms for improvement for the conventional vehicle nut holding apparatus 1.

### SUMMARY OF THE INVENTION

The primary object of the present invention is to provide a vehicle nut holding apparatus to allow a plurality of vehicle nuts to be held quickly and securely.

To achieve the foregoing object the vehicle nut has at least one protrusive portion and one indented portion adjacent to each other. The vehicle nut holding apparatus has housing troughs to hold the vehicle nuts. Each of the housing troughs has a bottom and a side wall abutting the bottom. The side wall has a retaining recess and a retaining boss corresponding respectively to the protrusive portion and the indented portion to retain the nut. The retaining recess is located between the retaining boss and the bottom. The housing trough may be formed in various profiles by altering the retaining boss and the retaining recess to mate the indented portion and protrusive portion of the vehicle nut. The holing apparatus thus formed can securely hold the vehicle nuts.

The holding apparatus of the invention can provide many benefits, notably:

1. For producers, fabrication and assembly can be done faster and more secured.

2. For consumers, when they purchase, the usage of vehicle nuts can be seen clearly due to well presentation and their usage can be differentiated easily.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional vehicle nut holding apparatus.

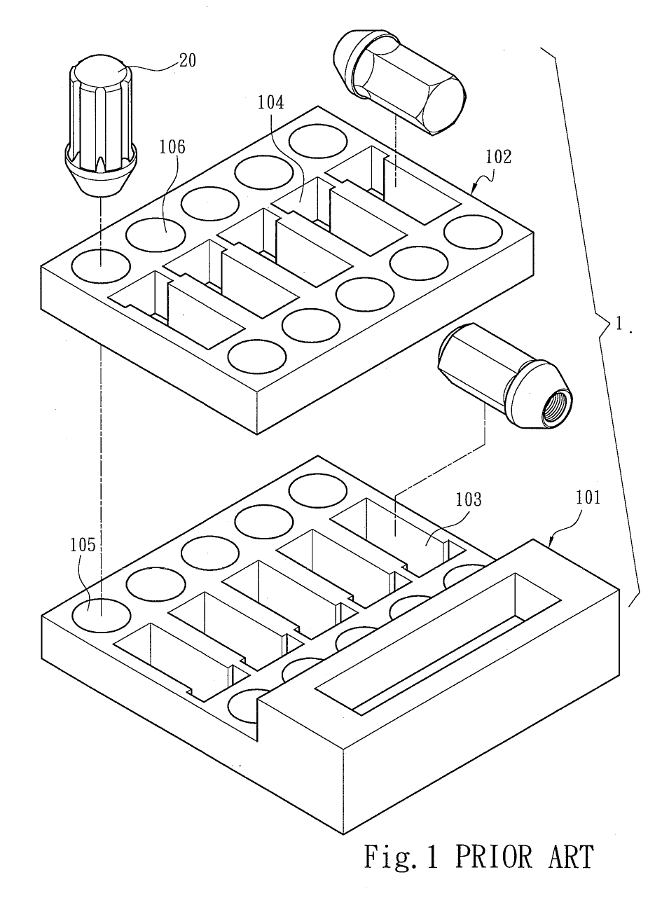

FIG. 2 is a schematic view of an embodiment of the invention.

FIG. 3 is a sectional view according to FIG. 2.

FIG. 4 is a schematic view of another embodiment of the invention.

FIG. 5 is a sectional view according to FIG. 4.

FIG. 6 is a schematic view of yet another embodiment of the invention.

FIG. 7 is a sectional view according to FIG. 6.

FIG.8 is another sectional view according to FIG. 6.

### DETAILED DESCRIPTION OF THE PREFERRED EMBODIMENTS

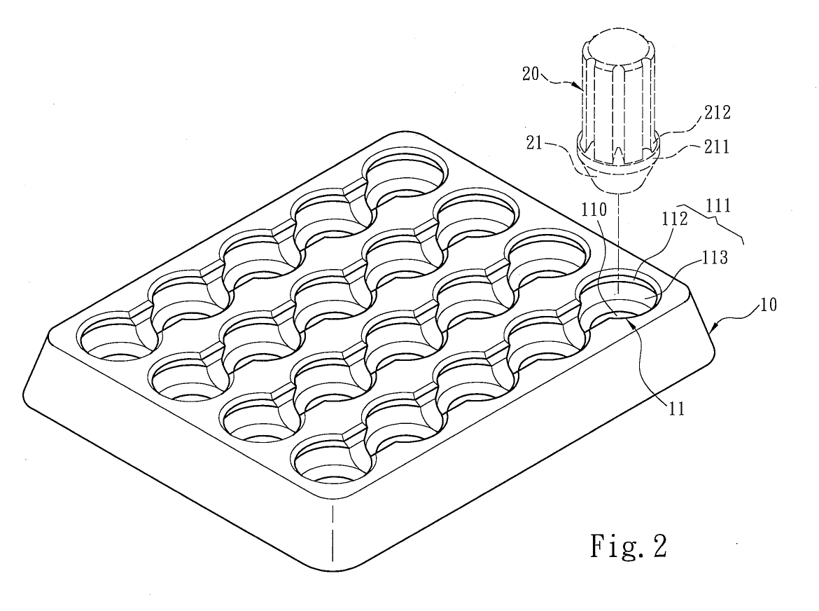

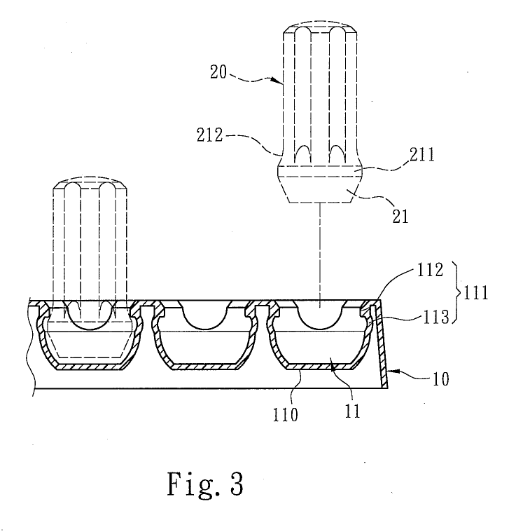

Please refer to FIGS. 2 and 3 for a first embodiment of the vehicle nut holding apparatus of the invention. It aims to hold vehicle nuts 20. Each of the vehicle nuts 20 has a conical portion 21 which has at least one protrusive portion 211 and at least one indented portion 212 formed on the peripheral surface of the conical portion 21 thereof adjacent to each other. The holding apparatus 10 has a plurality of housing troughs 11. When assembling, the vehicle nuts 20 are pre-arranged in desired holding position and then stamped, which makes the vehicle nuts 20 can be fast and fixedly retained on the housing troughs 11. Each housing trough 11 has a bottom 110 and a side wall 111 abutting the bottom. The side wall 111 has a retaining recess 113 and a retaining boss 112 corresponding respectively to the protrusive portion 211 and the indented portion 212 to form a retaining relationship. The retaining recess 113 is located between the retaining boss 112 and the bottom 110. In this embodiment the vehicle nut 20 can be inserted in the housing trough 11 in an upright manner to form a first displaying and holding condition.

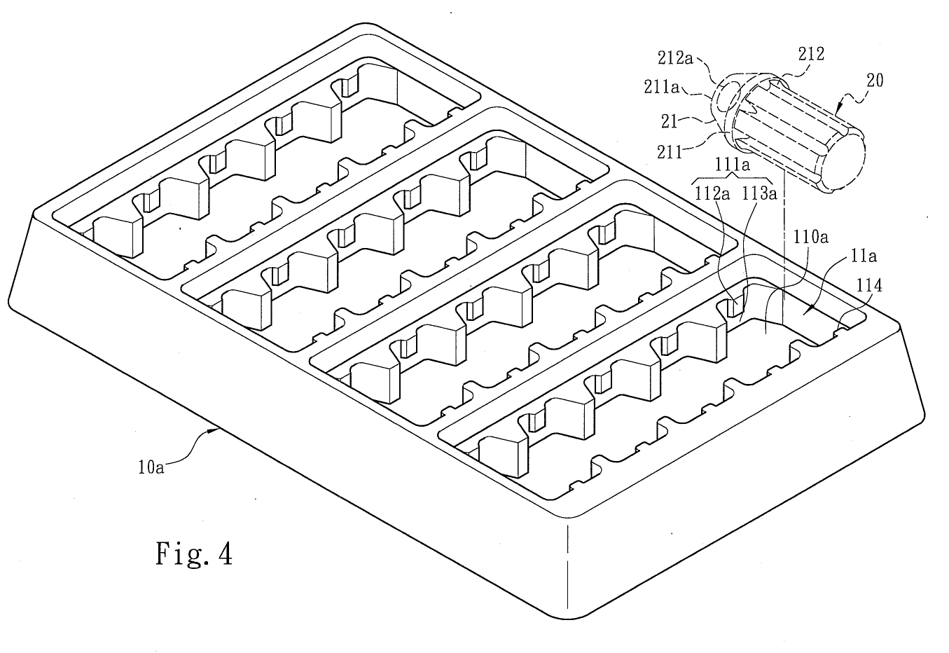

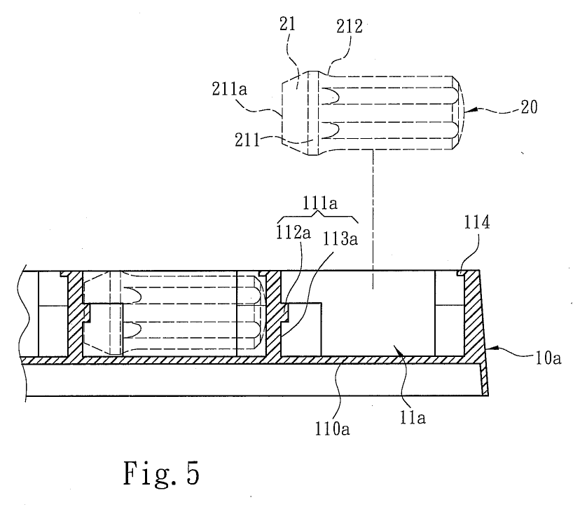

Refer to FIGS. 4 and 5 for a second embodiment of the invention. It differs from the first embodiment by positioning the vehicle nut 20 in a horizontal manner in the housing trough 11a. The conical portion 21, aside from having the indented portion 212a and protrusive portion 211a, also has a screw hole and a jutting rim formed on the edge of the screw hole. Thus the indented portion 212a and protrusive portion 211a can be held by the corresponding retaining boss 112a and retaining recess 113a of the side wall 111a of the housing trough 11a to form a second displaying and holding condition. The retaining recess 113a is located between the retaining boss 112a and the bottom 110a. The holding apparatus 10a further has a detent lug 114 on the housing trough 11a to aid clipping of the vehicle nut 20 to prevent the vehicle nut 20 from coming off when the holding apparatus 10a is flipped upside down.

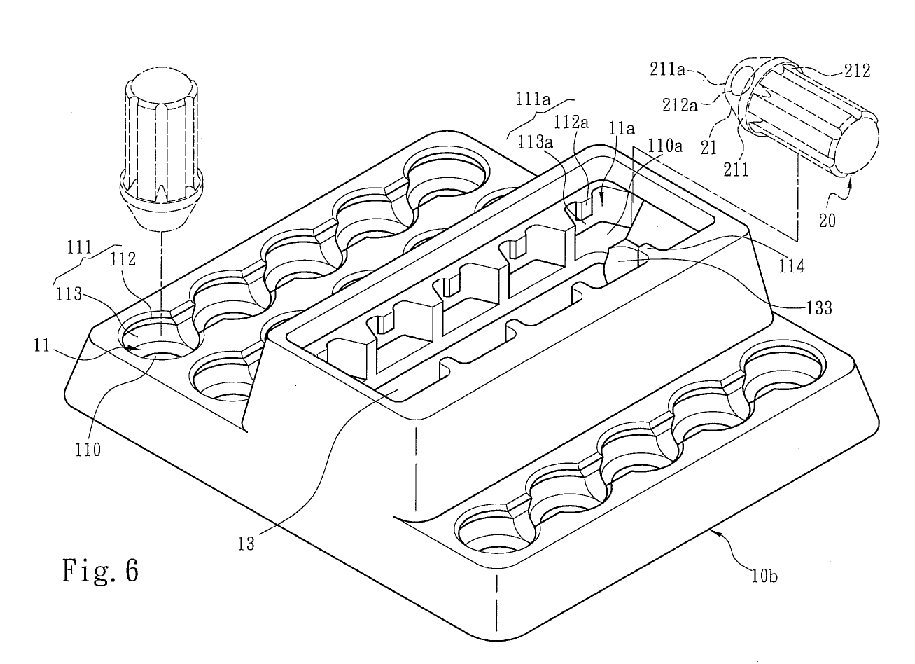

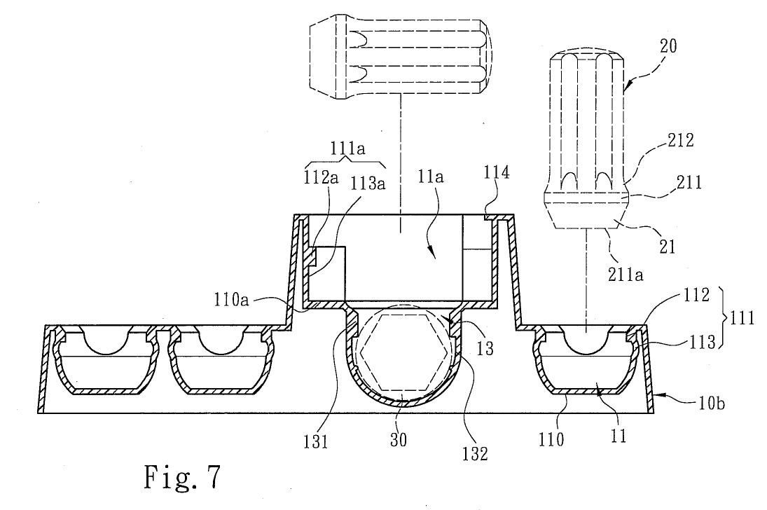

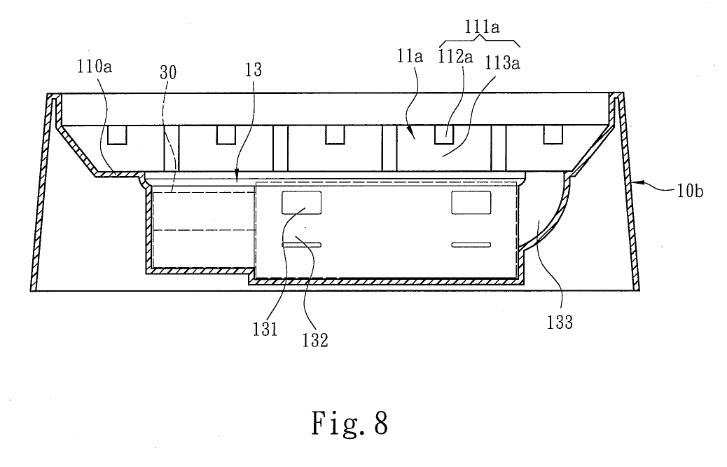

FIGS. 6, 7 and 8 shows yet another embodiment of the holding apparatus 10b by integrating the two previous embodiments to allow the vehicle nuts 20 to be held in housing troughs 11 and 11a in an upright manner or a horizontal manner in a third displaying and holding condition according to usage or desired displaying conditions. The housing trough 11a for holding the vehicle nut 20 in the horizontal condition has a holding trough 13 formed at the bottom 110a thereof to hold a nut removing tool 30. The holding trough 13 also has another retaining boss 131 and another retaining recess 132 to clip the nut removing tool 30. The housing trough 13 further has an aiding notch 133 to facilitate fetching of the nut removing tool 30. With the holding apparatus 10, 10a and 10b of the invention formed with corresponding concave and convex structures on the upper and lower sides, it can be stacked for storing to save more space than the conventional holding apparatus. By adapting the three embodiments previously discussed, a wide variety of combinations can be formed to meet users' ever changing requirements.

As a conclusion, the holding apparatus 10, 10a and 10b of the invention have the housing troughs 11 and 11a and side walls 111 and 111a with retaining bosses 112 and 112a, and retaining recesses 113 and 113a formed thereon to allow the vehicle nuts 20 to be selectively held and retained in an upright manner or horizontal manner. It provides many benefits over the conventional techniques, notably:

1. For producers, fabrication and assembly can be done faster and more secured.

2. For consumers, when they purchase, the vehicle nuts can be seen clearly due to well presentation and their usage can be differentiated easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A vehicle nut holding apparatus to hold vehicle nuts each having at least one protrusive portion and one indented portion adjacent to each other, comprising:
a holding apparatus having housing troughs to hold the vehicle nuts, each of the housing troughs having a bottom and a side wall abutting the bottom, the side wall having a retaining recess corresponding to the protrusive portion and a retaining boss corresponding to the indented portion to form a retaining relationship between them, the retaining recess being located between the retaining boss and the bottom.

2. The vehicle nut holding apparatus of claim 1, wherein the protrusive portion and the indented portion are formed on the peripheral surface of the vehicle nut.

3. The vehicle nut holding apparatus of claim 1, wherein the protrusive portion and the indented portion have a screw hole of the vehicle nut and a jutting rim on the edge of the screw hole.

4. The vehicle nut holding apparatus of claim 3 further having a detent lug formed in the housing trough to aid clipping of the vehicle nut.

5. The vehicle nut holding apparatus of claim 3, wherein the housing trough further has a holding trough to hold a nut removing tool.

6. The vehicle nut holding apparatus of claim 5, wherein the holding trough has another retaining boss and another retaining recess to anchor the nut removing tool.

7. The vehicle nut holding apparatus of claim 5, wherein the holding trough has an aiding notch at one side.
